(19) United States
(12) Patent Application Publication
(10) Pub. No.: US 2017/0155895 A1
(43) Pub. Date: Jun. 1, 2017

(54) GENERATION OF DRIVE VALUES FOR A DISPLAY

(71) Applicant: KONINKLIJKE PHILIPS N.V., EINDHOVEN (NL)

(72) Inventors: BART KROON, EINDHOVEN (NL); PATRICK LUC ELS VANDEWALLE, EINDHOVEN (NL)

(21) Appl. No.: 15/309,826

(22) PCT Filed: May 4, 2015
(86) PCT No.: PCT/EP2015/059641

§ 371 Date: Nov. 9, 2016

(30) Foreign Application Priority Data
May 12, 2014 (EP) 14167883.9

(51) Int. Cl. H04N 13/04

(52) U.S. Cl. CPC H04N 13/0497; H04N 13/0404; H04N 13/0422; H04N 13/0418

(57) ABSTRACT

An apparatus is arranged to generate sub-pixel drive values for sub-pixels of an autostereoscopic display. The display comprises a display panel (503) with the sub-pixels, and further comprises a view forming optical element (509), such as a lenticular screen, overlaid the display panel (503). The apparatus comprises a receiver (903) for receiving light output values for pixels of at least one image to be presented. A driver (905) generates the sub-pixel drive values. Specifically, it generates a first drive value for a first sub-pixel in response to a light output value for a pixel of which the first sub-pixel is a part, a sub-pixel value of at least one other sub-pixel and a cross-talk pattern reflecting sub-pixel cross-talk characteristics for sub-pixels of the autostereoscopic display. In addition, the sub-pixel drive values are biased towards extreme drive values, i.e. towards fully-on or fully-off values.

### FIELD OF THE INVENTION

The invention relates to generating drive values for sub-pixels of an autostereoscopic display, and in particular but not exclusively to generation of drive values based on a weaved image.

### BACKGROUND OF THE INVENTION

Three dimensional displays are receiving increasing interest, and significant research in how to provide three dimensional perception to a viewer is being undertaken. Three dimensional (3D) displays add a third dimension to the viewing experience by providing a viewer's two eyes with different views of the scene being watched. This can be achieved by having the user wear glasses to separate two views that are displayed. However, as this is relatively inconvenient to the user, it is in many scenarios desirable to use autostereoscopic displays that directly generate different views and projects them to the eyes of the user. Indeed, for some time, various companies have actively been developing autostereoscopic displays suitable for rendering three-dimensional imagery. Autostereoscopic devices can present viewers with a 3D impression without the need for special headgear and/or glasses.

Autostereoscopic displays generally provide different views for different viewing angles. In this manner, a first image can be generated for the left eye and a second image for the right eye of a viewer. By displaying appropriate images, i.e. appropriate from the viewpoint of the left and right eye respectively, it is possible to convey a 3D impression to the viewer.

Autostereoscopic displays tend to use means, such as lenticular lenses or barrier masks, to separate views and to send them in different directions such that they individually reach the user's eyes. For stereo displays, two views are required but most autostereoscopic displays typically utilize more views (such as e.g. nine views).

In order to fulfill the desire for 3D image effects, content is created to include data that describes 3D aspects of the captured scene. For example, for computer generated graphics, a three dimensional model can be developed and used to calculate the image from a given viewing position. Such an approach is for example frequently used for computer games which provide a three dimensional effect.

As another example, video content, such as films or television programs, are increasingly generated to include some 3D information. Such information can be captured using dedicated 3D cameras that capture two simultaneous images from slightly offset camera positions thereby directly generating stereo images or may e.g. be captured by cameras which are also capable of capturing depth.

Typically, autostereoscopic displays produce “cones” of views where each cone contains multiple views that correspond to different viewing angles of a scene. The viewing angle difference between adjacent (or in some cases further displaced) views are generated to correspond to the viewing angle difference between a user's right and left eye. Accordingly, a viewer whose left and right eye see two appropriate views will perceive a three dimensional effect. An example of such a system wherein nine different views are generated in a viewing cone is illustrated in FIG. 1.

Many autostereoscopic displays are capable of producing a large number of views. For example, autostereoscopic displays which produce nine views are not uncommon. Such displays are e.g. suitable for multi-viewer scenarios where several viewers can watch the display at the same time and all experience the three dimensional effect. Displays with even higher number of views have also been developed, including for example displays that can provide e.g. 28 different views. Such displays may often use relatively narrow view cones such that the viewer's eyes will receive light from a plurality of views simultaneously. Also, the left and right eyes will typically be positioned in views that are not adjacent (as in the example of FIG. 1).

An example of an image processing approach for increasing sharpness for images of a multi-view display are disclosed in EP 2 259 601A. An example of cross talk reduction for a dual image display is presented in US2008/0231547 A1. US 2009/0079680 A1 discloses a method for compensating light leakage in a dual-view display. A specific example of an autostereoscopic display using a lenticular lens array to provide a large number of views is presented in GB 2 314 203.

Autostereoscopic displays typically use lenticular or parallax-barrier technology to create the glasses-free 3D effect.

FIG. 2 illustrates an example of the formation of a 3D pixel (with three color channels) from multiple sub-pixels. In the example, w is the horizontal sub-pixel pitch, h is the vertical sub-pixel pitch, N is the average number of sub-pixels per single-colored patch. The lenticular lens is slanted by s=tan θ, and the pitch measured in horizontal direction is p in units of sub-pixel pitch. Within the 3D pixel, thick lines indicate separation between patches of different colors and thin lines indicate separation between sub-pixels. Another useful quantity is the sub-pixel aspect ratio: a=w/h. Then N=a/s. For the common slant ⅙ lens on RGB-striped pattern, a=⅓ and s=⅙, so N=2.

Inherent to autostereoscopic designs is a certain amount of cross-talk between adjacent views, caused by part of the light from adjacent (sub-)pixels coming through the lens in a similar direction.

The typical approach to counter cross-talk is to subtract a weighted version of the neighboring views from the current view at the same location, thereby trying to cancel the optical cross-talk. This leads to additional sharpness, but it also has a number of limitations. For example, the signal values are limited to a certain range (typically 8 bits for standard displays, more for HDR displays), so if the cross-talk compensation would add even more to a bright spot (or equivalently subtract from a dark spot), the value will be clipped to the extremes (0 or 255 for the 8-bit case).

A common problem with autostereoscopic displays is known as banding and can be defined as an involuntary intensity variation due to the magnification of the black matrix by the lenticular lens. FIG. 3 illustrates that banding can often be avoided or substantially reduced for a wide range of slant angles when the display has monolithic sub-pixels. With simple rectangular sub-pixels the most banding will occur for upright (non-slanted) lenticular lenses as illustrated by line A. When line A scans in column direction, the intensity can be found by integrating along the line. For most other slant angles the lens line B integrates over a similar amount of light emitting and non-light emitting areas when scanning the pixel grid, thus there is little intensity variation (and banding) (i.e. the accumulated intensity is not dependent on the horizontal position of lens line B).

However, for other geometric arrangements, such as the example of FIG. 4, banding is likely to occur for most slant angles. Such scenarios generally occur for displays wherein sub-pixels are made up of multiple light elements, Panels for such displays are becoming increasingly prevalent and provide advantages in terms of achievable image quality. However, lenticular displays that comprise such panels are also prone to moiré and cross-talk which washes out sharp low- and highlights. Accordingly, the image quality currently achieved tends to not meet that promised by the display technology.

Hence, an improved approach for driving autostereoscopic displays would be advantageous, and, in particular, an approach allowing increased flexibility, improved image quality, reduced complexity, reduced resource demand and/or improved performance would be advantageous.

### SUMMARY OF THE INVENTION

Accordingly, the Invention seeks to preferably mitigate, alleviate or eliminate one or more of the above mentioned disadvantages singly or in any combination.

According to an aspect of the invention there is provided apparatus for generating sub-pixel drive values for sub-pixels of an autostereoscopic display, the apparatus comprising: a first receiver for receiving light output values for pixels of at least one image to be presented; a driver for generating the sub-pixel drive values, the driver being arranged to generate a first drive value for a first sub-pixel in response to a light output value for a pixel of which the first sub-pixel is a part, in response to a sub-pixel value of at least one other sub-pixel, and in response to a cross-talk pattern reflecting sub-pixel cross-talk characteristics for sub-pixels of the autostereoscopic display; wherein the driver is arranged to bias the sub-pixel drive values for sub-pixels towards extreme drive values.

The invention may provide an improved driving of an autostereoscopic display, and may in particular in many scenarios provide improved image quality. The approach may in many scenarios provide improved color rendition, reduced moiré, increased sharpness, reduced cross-talk and/or reduced banding. The invention may in many embodiments allow efficient implementation, and the generation of the sub-pixel drive values may be by a relatively low complexity approach with relatively low resource usage (specifically with relatively low computational and memory resource usage).

The apparatus may be arranged to independently control the sub-pixels by taking the sub-pixel cross-talk into account and driving the sub-pixel drive values towards the extreme values, and thus away from mid-range values.

The light output values may specifically be provided as pixel values for the at least one image. In many embodiments, the light output values/pixel values may be provided for individual color channels, such as e.g. by different values being provided for e.g. a Red, Green and Blue color channel. Thus, the light output values may be RGB values for pixels of one or more images to be presented by the display. The light output values may represent desired pixel light output for the at least one image.

The at least one image may be a weaved image comprising a plurality of interleaved images with each of the images corresponding to a different view. The at least one image may be an image of a sequence of images, such as specifically an image or frame of a video sequence.

The driver may be arranged to seek to select the sub-pixel drive values to result in the light output from the pixel of which the first sub-pixel is a part to be similar to the light output indicated by the light output value for the pixel. The determination of the light output corresponding to a given value of the first sub-pixel drive value may include cross-talk contributions from other sub-pixels. The contribution may be determined based on the cross-talk pattern. In some embodiments, a simultaneous determination of drive values for a plurality of sub-pixels may be performed, and the values may be selected to correspond to the light output reflected by the light output value for the pixel but with the joint determination seeking to allocate as extreme values as possible to individual sub-pixels. For example, for a light output of 50% for a pixel comprising two sub-pixels (e.g. for the specific sub-channel), the driver may be arranged to set one sub-pixel drive value to minimize light output from that sub-pixel with the required light exclusively being provided by the other sub-pixel (e.g. rather than setting both sub-pixels to 50%, the driver may set one to 100% and the other to 0%).

In some embodiments, the first sub-pixel drive value may be set to a value that will result in the light output from the pixel differing from the value indicated by the light radiation value for the pixel. Specifically, the first sub-pixel drive value may be set to a more extreme value at the expense of the light output differing from the desired light output. In some embodiments, the difference may be taken into account when determining drive values for other sub-pixels, potentially belonging to other pixels. For example, if the light output is too high for one pixel, it may be set to be too low for a neighbor pixel.

The cross-talk pattern may reflect how the light output of sub-pixels is dependent on the light output of other sub-pixels and specifically on the drive values for other sub-pixels. In some embodiments, the cross-talk pattern may for example be a filter which for a given sub-pixel defines a proportion of the light from other sub-pixels that will radiate from this sub-pixel. In some embodiments, the cross-talk pattern may for example be a filter which for a given sub-pixel defines a proportion of the light from this sub-pixel that will radiate from other sub-pixels. Specifically, in some embodiments, the cross-talk pattern may be a filter which defines the light distribution from a first sub-pixel to other pixels (typically in a neighborhood of the first sub-pixel). In some embodiments, the cross-talk pattern may be a filter which defines the light distribution to a first sub-pixel from other pixels (typically in a neighborhood of the first sub-pixel).

The biasing for sub-pixel drive values may be towards more extreme drive values, i.e. towards drive values that are closer to the end-points of a range for the drive values. Specifically, it may bias dark sub-pixels towards drive values making the sub-pixels darker, and to bias bright sub-pixels towards drive values making the sub-pixels brighter.

The biasing of the sub-pixel drive values towards extreme drive values may be a biasing of the drive values away from a midpoint or mid-range of drive values. The drive values may be in a range from a minimum value corresponding to a minimum light output to a maximum value corresponding to a maximum light output. The biasing may be towards the nearest value of the maximum value and the minimum value. The biasing may be away from a midpoint between the maximum value and the minimum value or in some embodiments away from a range of values comprising the midpoint.

In some embodiments, there may be provided an autostereoscopic display comprising the apparatus. In some embodiments, there may be provided an integrated circuit comprising the apparatus.

The autostereoscopic display may comprise a display panel comprising the sub-pixels and a view forming/separating optical element which overlays the display panel and thus the sub-pixels. The cross-talk pattern may be any data reflecting sub-pixel cross-talk characteristics, and specifically may represent the correlation between light outputs of different sub-pixels.

In many embodiments, the autostereoscopic display comprises a display panel comprising the sub-pixels and a view forming optical element overlaying the display panel/sub-pixels, and the cross-talk pattern reflects characteristics of the view forming optical element.

The driver is arranged to generate the sub-pixel drive values by an optimization minimizing a penalty measure reflecting a distance between estimated light output resulting from selected sub-pixel drive values for a set of sub-pixels and light output corresponding to the light output values for pixels of which the sub-pixels of the set of sub-pixels are part, the penalty measure further being dependent on a distance of at least one sub-pixel drive value to a nearest end range value for the at least one sub-pixel drive value.

This may provide improved performance and may achieve a bias towards extreme values while generating a light output closely corresponding to the at least one image.

In many embodiments, the penalty measure may be a composite measure comprising a plurality of penalty values. In many embodiments, the penalty measure may be dependent on multiple parameters.

In many embodiments, the penalty measure may be dependent on a distance of at least one sub-pixel drive value to a midpoint drive value, the midpoint/midrange drive value corresponding to a median or mean light output for a sub-pixel.

In many embodiments, the penalty measure may comprise a penalty value being a monotonically increasing function of a distance of at least one drive value to a nearest end range value for the at least one drive value. In many embodiments, the penalty measure may comprise a penalty value being a monotonically decreasing function of a distance of at least one drive value to a mid-range drive value.

The optimization may specifically be a quadratic programming optimization. The optimization may often be a fast approximation as the optimization may often be seen as an NP (nondeterministic polynomial time) hard problem.

In accordance with an optional feature of the invention, the autostereoscopic display comprises a display panel comprising the sub-pixels and a view forming optical element overlaid the display panel, and the cross-talk pattern reflects a spatial proximity between the sub-pixels in the display panel.

This may provide improved performance, and in particular may provide improved image quality in many embodiments and scenarios.

The view forming optical element may specifically be a lenticular lens element, a barrier mask, or a parallax barrier.

In accordance with an optional feature of the invention, the autostereoscopic display comprises a display panel comprising the sub-pixels and a view forming optical element overlaid the display panel, and the cross-talk pattern reflects a view correlation between sub-pixels of the display panel.

This may provide improved performance, and in particular improved image quality in many embodiments and scenarios. In particular, it may provide improved autostereoscopic three dimensional image rendering. The view correlation for two sub-pixels may indicate the proximity of the views to which the two sub-pixels belong. In particular, it may reflect whether the sub-pixels belong to the same view, to adjacent views, or to views further apart.

In accordance with an optional feature of the invention, the cross-talk pattern reflects a human visual spatial contrast function.

This may provide improved performance, and in particular in a perceived improved image quality in many embodiments and scenarios.

In some embodiments, the cross-talk pattern may reflect a color correlation between sub-pixels.

In accordance with an optional feature of the invention, the driver is arranged to determine a reference drive value for the first sub-pixel corresponding to a desired light output from the first sub-pixel, the desired light output comprising a light output contribution from the first sub-pixel corresponding to the light output value for the pixel to which the first sub-pixel belongs; and to determine the first sub-pixel drive value by modifying the reference drive value to be closer to a nearest end range drive value.

The driver may be arranged to select a more extreme drive value even though this may result in the light output of the pixel (for that color channel) being different than that specified by the light output value for that pixel. Thus, a difference or error in the generated light output may be intentionally introduced to allow the sub-pixel drive value to take a more extreme value, i.e. for a dark sub-pixel to be darker and a bright pixel to be brighter.

The driver may thus determine the sub-pixel value(s) to be more extreme than that corresponding to the value which would resulting from simply seeking to provide a light output contribution as defined by the light output value for the pixel.

This may provide improved performance, and in particular may provide improved image quality in many embodiments and scenarios.

In accordance with an optional feature of the invention, the driver (905) is arranged to determine an error residue in response to a difference measure for the first sub-pixel drive value relative to the reference drive value; and to distribute the error residue over a group of sub-pixels.

This may provide improved performance and may allow improved image quality. The approach may allow sub-pixels to be allocated more extreme drive values while allowing the effect of any distortion introduced thereby to be reduced.

The error residue may reflect the error introduced to the light output of the sub-pixel by selecting a more extreme drive value, i.e. it may reflect the modification relative to the reference drive value. The error residue may for example be represented, analyzed, processed and/or determined as sub-pixel drive values, and/or may e.g. be represented, analyzed, processed and/or determined as sub-pixel light output measures.

The distribution of the error residue may be to one or more other sub-pixels. The distribution may be modifying the desired light output for the one or more other sub-pixels to compensate for the error residue of the first sub-pixel.

In some embodiments, the driver may be arranged to distribute the error residue by determining a compensation light output value for at least one other sub-pixel from the error residue. The light output value for the at least one other sub-pixel may modified in response to the compensation light output value, and the reference drive value for the at least one other sub-pixel may be determined based on the modified light output value.

The distribution may be by a distribution filter which describes the compensation to each of a set of sub-pixels from the error residue. The distribution filter may specifically be represented by a spatial filter which describes the contribution to each sub-pixel in a neighborhood of the sup-pixel from which the error residue is distributed. The spatial filter may be represented by a matrix, and the multiplication of the matrix by the error residue may result in a compensation matrix which provides the compensation values for each sub-pixel in the neighborhood covered by the spatial filter.

The error residue may specifically be distributed by a spatial dithering.

In many embodiments, the combination of compensation light output values may be substantially equal to the error residue.

In accordance with an optional feature of the invention, the driver is arranged to determine the reference drive value in response to error residue contributions to the first sub-pixel from other sub-pixels.

This may provide improved image quality and may in particular reduce the perceived distortion resulting from applying more extreme drive values.

In accordance with an optional feature of the invention, the driver is arranged to distribute the error residue in response to: a spatial proximity between sub-pixels; a view correlation between sub-pixels; a color correlation between sub-pixels; and a human visual spatial contrast function.

This may provide particularly advantageous performance and may in many embodiments increase the image quality of the displayed image.

In some embodiments, the driver may be arranged to distribute the error residue using an error residue distribution filter defining contributions from the error residue to a group of sub-pixels. The error residue distribution filter may be a combination filter generated by combining at least some of a spatial proximity filter, a view correlation filter, a visibility filter, and a color correlation filter.

In accordance with an optional feature of the invention, the driver is arranged to sequentially determine drive values for the sub-pixels; and to distribute error residue for a sub-pixel to only sub-pixels subsequent to the sub-pixel.

This may reduce complexity and may substantially reduce the computational resource. It may in many embodiments allow the driver to process the at least one image to determine drive values in a single pass, i.e. each drive value is determined only once and no iterative or recursive algorithm is required.

In accordance with an optional feature of the invention, the autostereoscopic display is arranged to display a first set of views by presenting a weaved image comprising interleaved images for the first set of views, and the apparatus further comprises: a second receiver for receiving at least one image for a second set of views; an image combiner for generating the weaved image from the at least one image for the second set of views; and wherein the driver is arranged to determine the sub-pixel drive values by processing sub-pixels of the weaved image.

This may provide improved performance, and/or may allow reduced complexity in many embodiments.

In accordance with an optional feature of the invention, the autostereoscopic display is arranged to display a first set of views by presenting a weaved image comprising interleaved images for the first set of views, and the apparatus further comprises: a receiver for receiving at least one image for a second set of views; and wherein the driver is arranged to determine the sub-pixel drive values as sub-pixel drive values of the weaved image by processing sub-pixels of the at least one image for a second set of views.

This may provide improved performance, and/or may allow reduced complexity in many embodiments.

In accordance with an optional feature of the invention, the at least one image is an image of a sequence of image frames and the driver is arranged to vary the bias for individual sub-pixels of the images between subsequent images.

This may provide improved perceived image quality in many embodiments.

According to an aspect of the invention there is provided a method of generating sub-pixel drive values for sub-pixels of an autostereoscopic display, the method comprising: receiving light output values for pixels of at least one image to be presented; generating the sub-pixel drive values including generating a first drive value for a first sub-pixel in response to a light output value for a pixel of which the first sub-pixel is a part, in response to a sub-pixel value of at least one other sub-pixel, and in response to a cross-talk pattern reflecting sub-pixel cross-talk characteristics for sub-pixels of the autostereoscopic display; and wherein generating the sub-pixel drive values comprises biasing the sub-pixel drive values for sub-pixels towards extreme drive values by generating the sub-pixel drive values by an optimization minimizing a penalty measure reflecting a distance between estimated light output resulting from selected sub-pixel drive values for a set of sub-pixels and light output corresponding to the light output values for pixels of which the sub-pixels of the set of sub-pixels are part, the penalty measure further being dependent on a distance of at least one sub-pixel drive value of the selected sub-pixel drive values to a nearest end range value for the at least one sub-pixel drive value.

These and other aspects, features and advantages of the invention will be apparent from and elucidated with reference to the embodiment(s) described hereinafter.

### BRIEF DESCRIPTION OF THE DRAWINGS

Embodiments of the invention will be described, by way of example only, with reference to the drawings, in which

FIG. 1 illustrates an example of views generated from an autostereoscopic display;

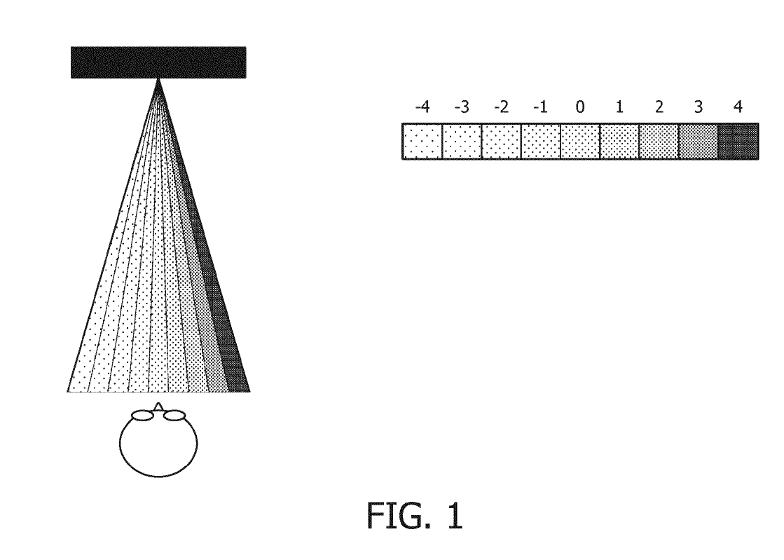

FIG. 2 illustrates an example of a lenticular screen overlaying a display panel of an autostereoscopic display;

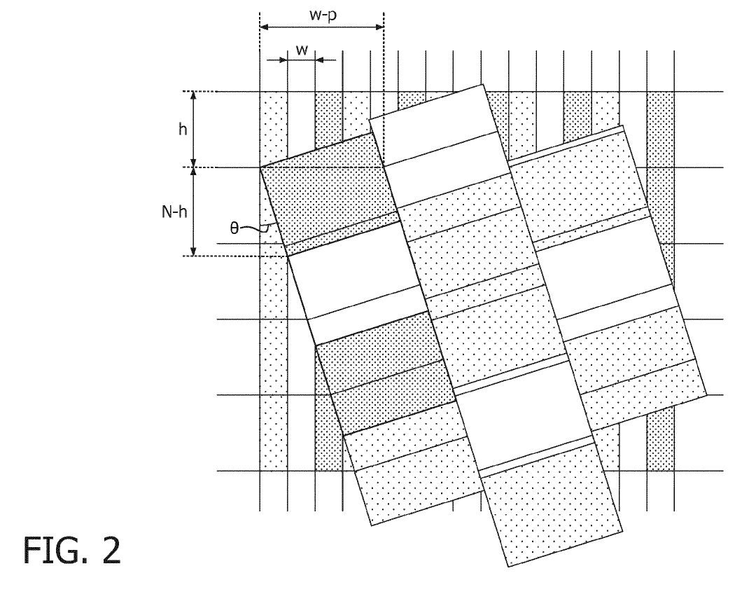

FIG. 3 illustrates an example of a layout of a display panel of an autostereoscopic display;

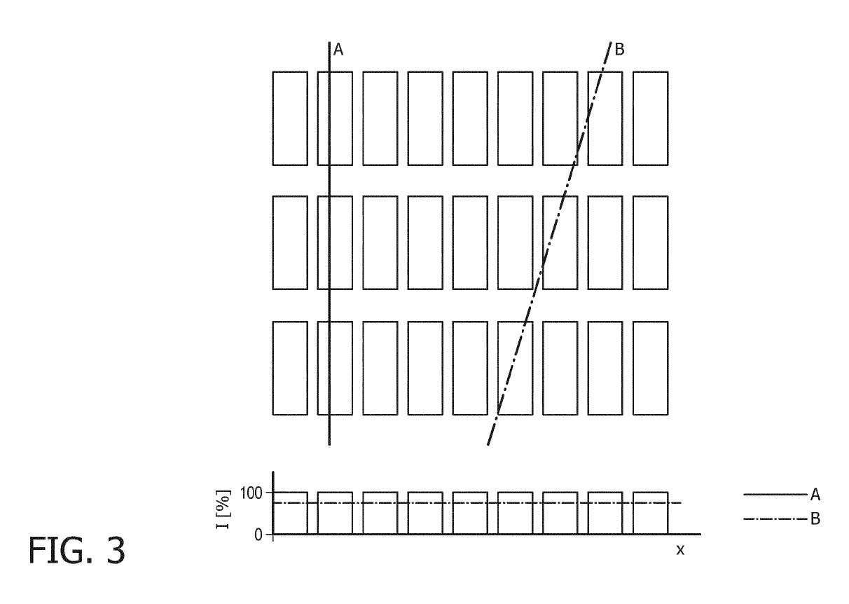

FIG. 4 illustrates an example of a layout of a display panel of an autostereoscopic display;

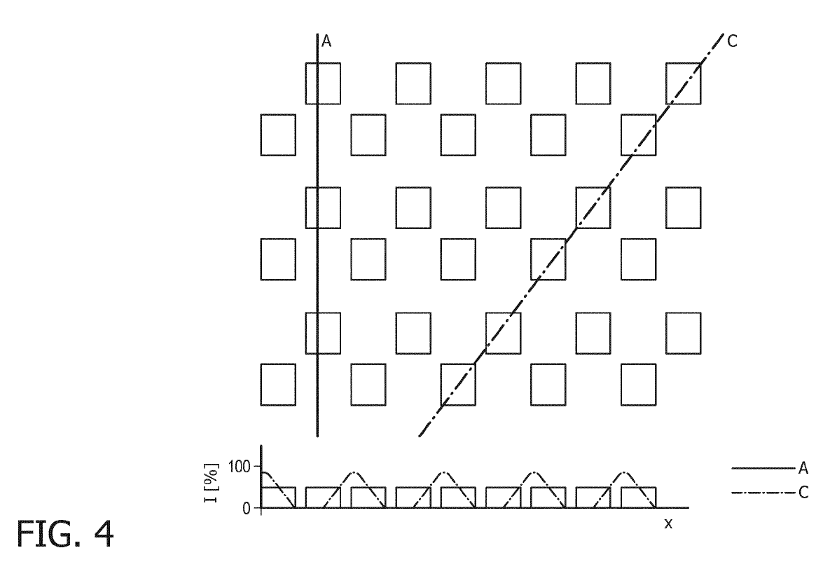

FIG. 5 illustrates a schematic perspective view of elements of an autostereoscopic display device;

FIG. 6 illustrates a cross sectional view of elements of an autostereoscopic display device;

FIG. 7 illustrates a schematic representation of a layout of sub-pixels on a display panel, with a representation of a lenticular superimposed;

FIG. 8 illustrates a schematic representation of one view of an autostereoscopic image obtainable with the layout and lenticular of FIG. 7;

FIG. 9 illustrates an example of elements of a display driver in accordance with some embodiments of the invention; and

FIG. 10 illustrates an example of cross-talk patterns for an autostereoscopic display.

### DETAILED DESCRIPTION OF SOME EMBODIMENTS OF THE INVENTION

In the following, the term sub-pixel will be used to denote a light-modulating element that is independently addressable (typically by use of at least one row line and one column line). Sub-pixels are also referred to as independent color component addressable. Typically, a sub-pixel comprises an active matrix cell circuit. Light may be modulated by altering emission, reflectance, and/or transmission of light in the sub-pixel. Note that the light may be produced in the sub-pixel itself, or the light may originate in a light source external to the sub-pixel, e.g., for use in a projector such as an LCD projector. A sub-pixel is also referred to as ‘cell’.

The term ‘pixel’ will be used to denote a smallest group of collocated sub-pixels that can produce all colors that the display is capable of producing. Pixels are also referred to as independent full color addressable.

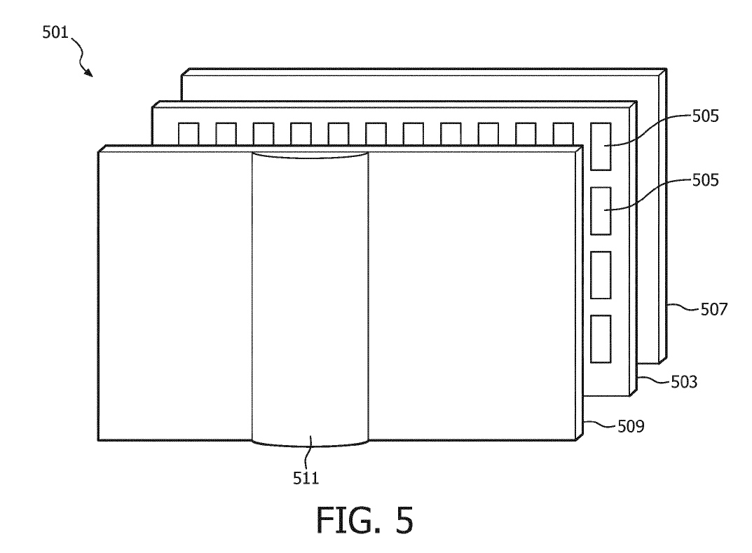

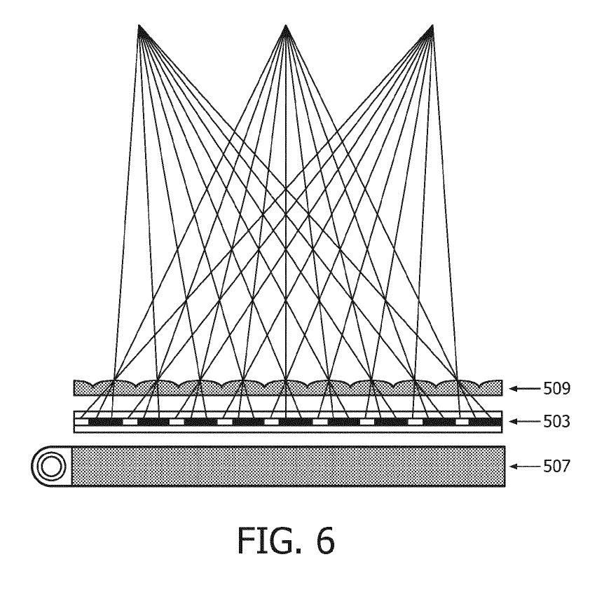

FIG. 5 illustrates a schematic perspective view of an autostereoscopic display. FIG. 6 illustrates a schematic cross sectional view of the display shown in FIG. 5.

The autostereoscopic display 501 comprises a display panel 503. The display 501 may contain a light source 507, e.g., when the display is an LCD type display, but this is not necessary, e.g., for OLED type displays.

The display device 501 also comprises a lenticular sheet 509, arranged over the display side of the display panel 503, which performs a view forming function. The lenticular sheet 509 comprises a row of lenticular lenses 511 extending parallel to one another, of which only one is shown with exaggerated dimensions for the sake of clarity. The lenticular lenses 511 act as view forming elements to perform a view forming function. The lenticular lenses of FIG. 5 have a convex facing away from the display panel. It is also possible to form the lenticular lenses with their convex side facing towards the display panel.

The lenticular lenses 511 may be in the form of convex cylindrical elements, and they act as a light output directing means to provide different images, or views, from the display panel 503 to the eyes of a user positioned in front of the display device 501.

The autostereoscopic display device 501 shown in FIG. 5 is capable of providing several different perspective views in different directions. In particular, each lenticular lens 511 overlies a small group of display sub-pixels 505 in each row. The lenticular element 511 projects each display sub-pixel 505 of a group in a different direction, so as to form the several different views. As the user's head moves from left to right, his/her eyes will receive different ones of the several views, in turn.

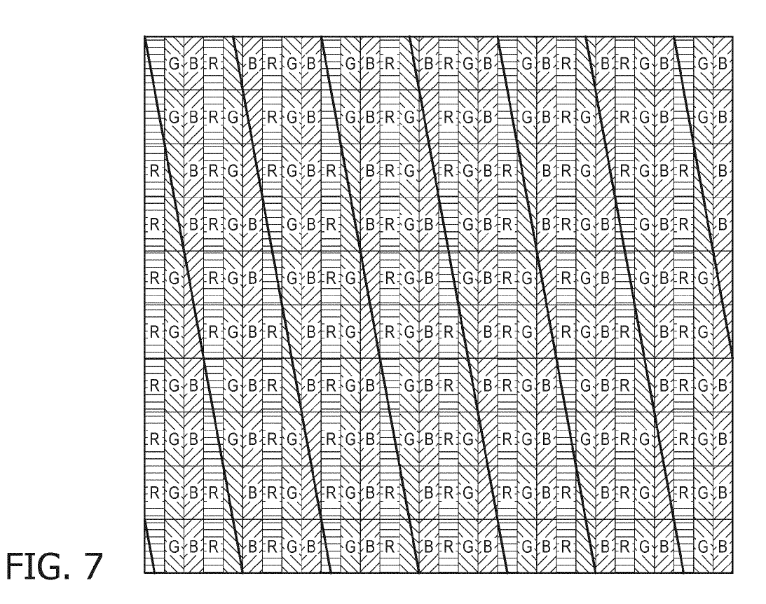

FIG. 7 illustrates a schematic representation of a layout of sub-pixels on a display panel, with a representation of a lenticular superimposed. Shown is an RGB-striped layout of sub-pixels; three of which form pixels. In the display panel, the sub-pixels are organized on a rectangular grid, in which columns of red, green, and blue are repeated. Superimposed on the panel, a lenticular is shown. Note the lenticular is slanted with respect to the columns in the sub-pixel layout. In FIG. 7, the lens-effect is not shown.

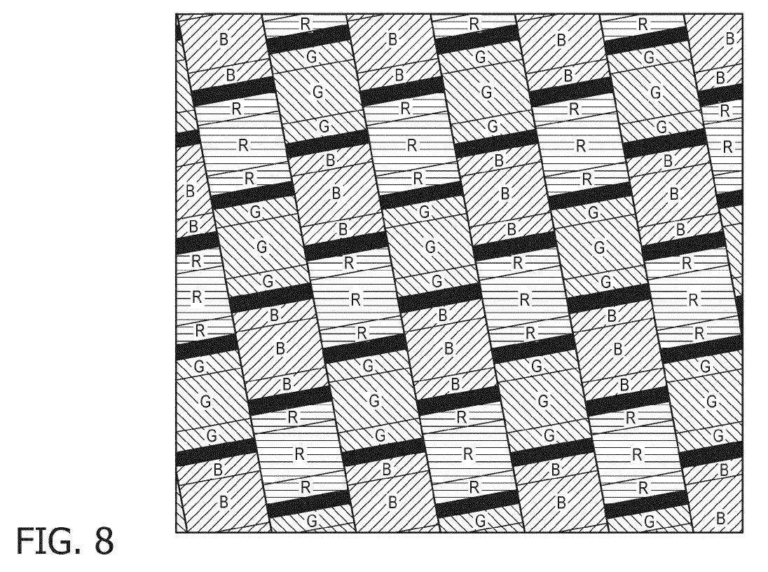

FIG. 8 illustrates a schematic representation of a view of an autostereoscopic image obtainable with the layout and lenticular of FIG. 7. Both in FIGS. 7 and 8, black bars are visible. The latter correspond to non-image forming parts of the panel, e.g., to support data lines, address lines and the like. The bars are slightly wider in FIG. 8 due to a magnifying effect of the lenticular.

Although the specific example is based on a view forming layer in the form of a lenticular screen it will be appreciated that other elements may be used in other embodiments, such as e.g. a parallax barrier.

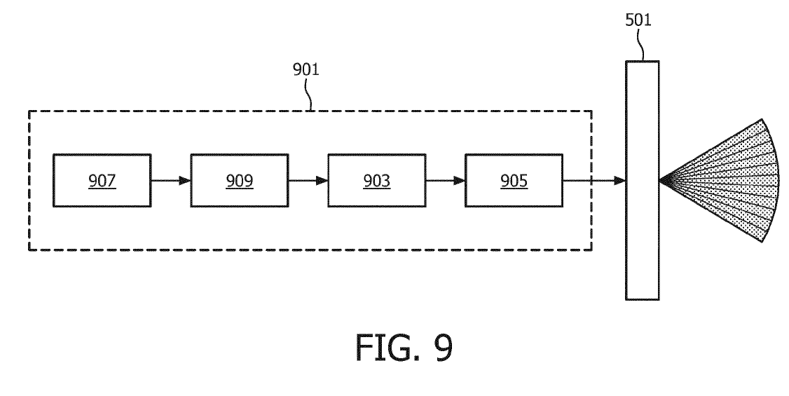

FIG. 9 illustrates an example of elements of a display driver 901 for an autostereoscopic display 501. The display driver 901 may be an integral part of the autostereoscopic display or may be a separate entity or device. For example, the display driver 901 may be implemented in an integrated circuit (custom IC, FPGA etc.) with this IC potentially being part of the display or part of a separate board or device.

The display driver 901 comprises a first receiver 903 which receives a weaved image to be presented on the autostereoscopic display 501. As will be known to the person skilled in the art, a lenticular screen may project neighboring pixels in different directions thereby creating a plurality of views. Typically, adjacent pixels accordingly belong to different views, and indeed the pixels are typically divided into groups of pixel columns where each group comprises a pixel column for each view. The display panel may thus be divided into column groups where each group comprises one pixel column for each view. Pixels that are horizontally adjacent in a given view belong to different groups and horizontally adjacent pixels on the display panel 503 belong to images for different views.

For example, an autostereoscopic display capable of displaying N views (N may typically be e.g. 9 or 28) may essentially render N images with each of the N images corresponding to one view. This is achieved by forming column groups comprising N pixel columns with one pixel column being included for each of the view images. The order of the pixel columns correspond to the order of the views and adjacent columns in the view images are included in adjacent column groups. The resulting image wherein all the N view images are interleaved is then rendered on the display panel with the lenticular lens resulting in the different view images being rendered in different directions. The interleaved image which is rendered on the display panel 503 is known as a weaved image.

The first receiver may receive the weaved image from any external or internal source, and may e.g. be implemented as a memory buffer in which the weaved image may be stored e.g. by a firmware routine generating the weaved image from separate view images.

The first receiver 903 is coupled to a driver 905 which is arranged to generate drive values for the sub-pixels of the display panel from the weaved image. The weaved image is represented by pixel values that describe the desired light output for the pixel. Typically, light values are provided for each pixel for a plurality of color channels, such as for a Red, Green, and Blue color channel, or e.g. for a Red, Green, Blue and White color channel (i.e. the desired light outputs may be described by e.g. RGB or RGBW values). In many embodiments, multi-primary color values, such as RGBW (or RGBY) values may be derived from e.g. RGB values in the driver for the display. In some embodiments, the first receiver 903 may comprise functionality for such a conversion to multi-primary values.

The driver 905 is arranged to generate sub-pixel drive values for the display panel based on the light output values for the weaved image. The driver 905 may specifically seek to generate the sub-pixel drive values such that the rendered view images most closely correspond to the images described by the light output values received by the first receiver 903 (in accordance with a suitable criterion typically taking into account different relevant quality characteristics and properties).

In many embodiments, the display panel may comprise a plurality of sub-pixels for each pixel for at least one of the color channels. For example, for each pixel, there may be two individually addressable green light emitting elements, i.e. each pixel may comprise two green sub-pixels. Such a plurality of sub-pixels per pixel may provide increased flexibility and additional freedom in how to drive the display panel 503.

In the system of FIG. 9, the driver is arranged to generate the sub-pixels to take into account the cross-talk characteristics of the display. Specifically, the light emitted from light emitting element may spread to other areas than the specific area of the light element. The driver 905 takes such light distribution into account.

Specifically, when determining a drive value for a given sub-pixel, the driver 905 takes into account the desired light output as defined by the pixel value/light output value for the pixel to which the sub-pixel belongs. Specifically, it may seek to determine a sub-pixel drive value that results in the light output for the pixel being close to the desired light output. The driver 905 may determine the light output resulting from different sub-pixel drive values and select the value that best meets a given criterion. When calculating the light output, the driver 905 may take into account the light output from all sub-pixels belonging the pixel (and that color channel). In addition, it takes into account the light output that results from cross-talk from light from sub-pixels of other pixels.

In particular, when determining the sub-pixel drive values, the driver 905 considers a cross-talk pattern which reflects sub-pixel cross-talk characteristics for sub-pixels of the autostereoscopic display. The cross-talk pattern may specifically be a spatial filter describing the cross-talk from sub-pixels in a neighborhood of a current sub-pixel or a spatial filter describing the cross-talk to sub-pixels in a neighborhood of a current sub-pixel.

In addition, the driver 905 is arranged to bias the sub-pixel drive values for sub-pixels towards extreme drive values. The biasing may specifically be towards end values of a range of values for the drive values, and specifically towards the drive values corresponding to minimum and maximum light output from the sub-pixel. In some embodiments, the biasing may be away from a mid-range or mid-point of the range of drive values, or specifically away from a drive value corresponding to a mean or median light output from the sub-pixel.

The driver 905 may accordingly be arranged to independently control the sub-pixels using an algorithm that takes into account the display cross-talk profile to promote extreme levels.

The biasing may for example be achieved by the driver 905 calculating the resulting pixel light output for all possible drive values for all sub-pixels of a pixel while taking into account the cross-talk from other sub-pixels. For each possible combination of drive values, a penalty value may be calculated which takes into account both how close the resulting light output is to the desired light output as described by the pixel value, and how extreme the drive value is, i.e. how close it is to the nearest end range value/how far from a midrange value. The penalty value may increase the larger the difference in light output and the less extreme the drive values are. The driver 905 may then select the set of drive values resulting in the lowest penalty value. In other embodiments, the driver may for example seek to minimize cross-talk caused to other sub-pixels from the current sub-pixel.

The driving towards extreme values may provide an advantageous operation and in particular improved image quality. For example, the approach may for example result in a sharper 3D picture with less cross-talk between views.

In some embodiments, display driver 901 may directly receive the weaved image, and the first receiver 905 may directly receive the weaved image to be presented. However, in many embodiments, the display driver 901 may comprise functionality for generating the weaved image from one or more single view images.

The weaved image comprise interleaved images for a first set of views presented by the autostereoscopic display. The first set of views may for example comprise 9 or 28 different views.

In the example of FIG. 9, the display driver 901 further comprises a second receiver 907 which is arranged to receive at least one image for a second set of views. The second set of views may typically be different from the first set of views.

The second receiver 907 is coupled to an image combiner 909 which is further coupled to the first receiver 903. The image combiner 909 is arranged to generate the weaved image from the at least one image for the second set of views and to provide the resulting weaved image to the first receiver 903. For example, the image combiner 909 may generate the weaved image from the received input image(s) and may store the resulting weaved image in a memory buffer implementing the first receiver 903.

In some embodiments, the second receiver 907 may receive single view images. These single view images may in some embodiments directly correspond to the view images to be presented by the autostereoscopic display. For example, for a 28 view autostereoscopic display, the display driver 901 may receive 28 images with each image corresponding to one of the views. In such an example, the image combiner 909 may proceed to generate the weaved image by interleaving and combining the received input single view images.

In other embodiments, the received single view images may not correspond to the view images to be presented. For example, a higher or lower number of images may be received. In such examples, the image combiner 909 may be arranged to first generate single view images corresponding to the views to be rendered and the weaved image may be generated by then interleaving these images.

The generation of the single view images for rendering may be based on e.g. interpolation or extrapolation from the received image. For example, in some embodiments, a substantially larger number of input single view images may be received than required for rendering. In such a case, the appropriate view images to be rendered may e.g. be generated by interpolation and/or selection from the received input images.

In some embodiments, fewer input single view images may be received. For example, in the extreme case, even a single input image may be received. In this case, the image may for example be associated with depth information (for example, an image plus depth representation may be used). In this case, the image combiner 909 may be arranged to generate the images for rendering by view shifting of the received input image based on the depth information.

As another example, the second receiver 907 may receive a stereoscopic image (with one image for each of the left and right eye of a user) and the image combiner 909 may proceed to apply view shifting to this to generate the appropriate view images for inclusion in the weaved image.

In many embodiments, the driver 905 may seek to perform an optimization which may simultaneously take into account a plurality of sub-pixels. In many embodiments, the driver 905 may be arranged to generate the sub-pixel drive values by an optimization that minimizes a penalty measure reflecting a difference between estimated light output resulting from selected sub-pixel drive values and that described by the light output values. The penalty value may be one which is dependent both on this difference and on a distance of at least one sub-pixel drive value to a nearest end range value for the at least one drive value, or equivalently may be dependent on a distance to a median or mean drive value, e.g. corresponding to a mean or median light output.

For a constant difference between the estimated light output and the desired light output, the penalty value may for example increase the closer the drive value is to a mean drive value corresponding 50% light output for the sub-pixel. Similarly, for a constant drive value, and thus a constant distance to the mean drive value, the penalty value increases the larger the difference between the calculated light output for that drive value and the desired light output (as determined from the received pixel values for the image).

The estimated light output is determined taking into account the light resulting from cross-talk from other sub-pixels. The cross-talk contribution is determined based on the pattern reflecting the cross-talk characteristics of the display.

As a specific low complexity example, the driver 905 may proceed to sequentially process each pixel of the weaved image, for example starting from the top left corner pixel and proceeding through all pixels in a given order (e.g. row by row, zig-zag, meandering etc.). Furthermore, the driver may proceed to treat each color channel independently.

For example, the driver 905 may for a first color channel and for each pixel estimate the light output for all possible drive values of the sub-pixels of that color channel and that pixel. For example, if the pixel comprises two sub-pixels of the color channel, the driver 905 may proceed to evaluate the light output from the pixel for all possible pairs of drive values for the color channel sub-pixels.

For each possible combination, the resulting light output is calculated. This calculation takes into account the light being output from the sub-pixels of the current pixel but also includes the cross-talk contribution from sub-pixels of other pixels (typically of the same color channel). This cross-talk contribution may be determined based on the cross-talk pattern which is indicative of the amount of light that is output from the current pixel but originates from other sub-pixels.

In the example, the cross-talk contribution to the light output may be generated based only on the sub-pixels for which drive values have already been determined. Thus, the cross-talk contribution from subsequent sub-pixels is not taken into account at this stage.

The resulting light output for all possible drive value (combinations) and from cross-talk is determined and a distance measure is calculated which indicates the distance between the estimated/calculated light output and the desired light output as defined by the input pixel value. It will be appreciated that any suitable distance measure can be used, such as a simple difference value.

The driver 905 then proceeds to calculate a penalty value for each possible drive value combination. The penalty value is dependent on the distance measure and on how extreme the drive value(s) is(are). It will be appreciated that the specific formula used for calculating a penalty value will depend on the characteristics and preferences of the individual embodiment. For example, in some embodiments it may be calculated as a weighted sum of a difference between the estimated and desired light output, and a difference between each drive value and a mean drive value. The weights may be adjusted to provide the desired performance.

The driver 905 then proceeds to select the drive value combination that results in the lowest penalty value. Thus, the sub-pixel drive values for the sub-pixels of the current pixel are determined as those resulting in the lowest penalty value.

The driver 905 may then proceed to the next pixel and perform the same operation. In this case, the cross-talk to the new pixel from the just determined pixel will be taken into account when determining the estimated light output.

Once all pixels have been processed, drive values have been generated for all sub-pixels for the color channel. However, the drive values have been generated considering cross-talk contributions only from sub-pixels for which drive values have previously been determined. This may result in suboptimal performance and specifically may result in reduced image quality. Accordingly, the driver 905 may proceed to perform a second pass. The approach in the second pass may be the same as the approach in the first pass except that a cross-talk contribution is included for sub-pixels for which drive values have not yet been determined in the second pass by using the drive values determined in the first pass. In some embodiments, the driver 905 may perform more passes to determine more accurate results.

It will be appreciated that more complex optimization approaches may be used in other embodiments. For example, a quadratic programming may be used.

As a specific example, this approach may be based on minimizing an equation of the form:

J=½\vec{x}^{T}Q\vec{x}+\vec{c}^{T}\vec{x}

subject to constraints on \vec{x}.

A is a sparse matrix that represents the cross-talk model (i.e. A may represent a cross-talk pattern), \vec{w} is the input image, and \vec{x} represents the sub-pixel drive values. The cross-talk is modelled as a FIR filter (A) giving actual values A\vec{x} instead of sub-pixel values \vec{x}. Ideally A\vec{x}=w in which case all cross-talk has been perfectly compensated. In practice, reconstruction is not ideal. The squared error can be used as an optimization function:

$$\begin{matrix}J = \frac{1}{2} {( A {x}^{->} - {w}^{->} )}^{T} ( A {x}^{->} - {w}^{->} ) \\ = \frac{1}{2} {{x}^{->}}^{T} {A}^{T} A {x}^{->} - {{w}^{->}}^{T} A {x}^{->} - \frac{1}{2} {{w}^{->}}^{T} {w}^{->} .\end{matrix}$$

In this example, the optimization process can thus be expressed as follows:

min_{\vec{x}}½\vec{x}^{T}A^{T}A\vec{x}−\vec{w}^{T}A\vec{x}

Constrained to 0≦xᵢ≦1, such that Q=A^{T} A and \vec{c}=−\vec{w}^{T} A.

In practice, the above problem can be solved approximately by a small number of iterations, and the person skilled in the art will be aware of different approaches to quadratic programming.

The approach may allow the drive values to be biased towards the extreme values, and specifically towards values corresponding to a fully OFF (0) or fully ON (1) setting of the sub-pixels. This may be achieved by introducing a penalty for \vec{x} being near 0.5 and this can be incorporated in A and w.

Specifically, the penalty for xᵢ being near 0.5 may take the form −tΣᵢ(xᵢ−½)² for positive t. Hence the penalty can be incorporated in Q and \vec{c} by:

Q′=Q−2tI

\vec{c}′=\vec{c}+t

Here t is a positive number that represents a tradeoff between representing the reference values and driving to extreme values.

The cross-talk pattern provides a description of the cross-talk characteristics of the autostereoscopic display. The cross-talk pattern may further be determined to reflect various specific characteristics and properties reflecting the impact of the viewer of the cross-talk.

Specifically, the cross-talk pattern may in some embodiments reflect a spatial proximity between the sub-pixels in the display panel. Specifically, sub-pixels that are close to each other typically provide a higher degree of cross-talk than sub-pixels that are further apart, and this may be reflected in the cross-talk pattern.

In some embodiments, the cross-talk pattern may reflect a view correlation between sub-pixels of the display panel. The view correlation may reflect the view distance between the sub-pixels. Specifically, the cross-talk pattern may reflect whether sub-pixels belong to the same view, to neighbor views, or to views that are further apart.

Thus, the cross-talk pattern may reflect that adjacent sub-pixels (or pixels) in the weaved image may have a higher physical cross-talk value than sub-pixels that are further apart, but that the perceived impact of further apart sub-pixels may have a much higher effect if they are directed in the same view direction. Thus, the view forming layer 509 (the lenticular screen), separates the light from the display panel 503 in different view directions and this may be reflected in the cross-talk pattern.

The approach may for example allow the cross-talk pattern to be used directly with the weaved image. This is an efficient approach because it allows a cross-talk filter representing the cross-talk pattern to be expressed as a two-dimensional spatial model. In some embodiments, the cross-talk pattern may reflect a human visual spatial contrast function. A human visual spatial contrast function reflects a visibility of line pairs to the human eye as a function of spatial frequency (magnitude). Spatial frequency is typically expressed as a visual angle. The human visual spatial contrast function thus reflects the sensitivity of a human observer to spatial contrast as a function of spatial frequency.

The use of a human visual spatial contrast function may be advantageous as it takes into account that tiny details are not visible to the viewer, and this allows a more aggressive filtering to be applied.

In some embodiments, the cross-talk pattern may reflect a color correlation between sub-pixels. Typically, the color filters for e.g. RGB displays will result in the different color channels being substantially independent with negligible cross-talk between the color channels. However, in some embodiments, such as specifically when using multi-primary displays, such as e.g. RGBW displays, there may be cross correlation between different color channels.

In such scenarios, the cross-talk pattern may reflect the cross-talk between different color channels. Furthermore, the cross-talk pattern may reflect the color correlation, and specifically how spectrally similar the color channels are. For example, for the cross correlation from a W-sub-pixel to a G-sub-pixel, the cross-talk value may reflect how much of the light from the W sub-pixel is in the frequency pass band corresponding to the G-sub-pixel.

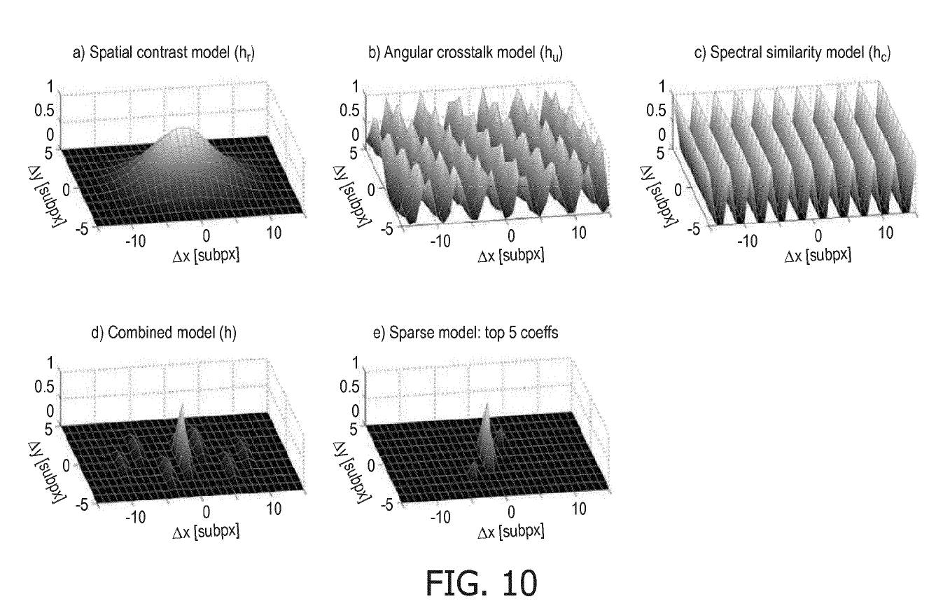

FIG. 10 illustrates an example of a cross-talk pattern in the form of a filter which can be applied directly to the weaved image. FIG. 10a shows the spatial filtering (reflecting distance of the sub-pixels in the weaved image). FIG. 10b illustrates view filtering where the view correlation is taken into account. FIG. 10c takes into account the spectral similarity of the respective colors of different sub-pixels (typically used for multi-primary panels. FIG. 10d illustrates the combined filter and FIG. 10e illustrates a sparse version of the combined filter.

In some embodiments, the driver 905 may be arranged to use a spatial dithering approach to allow sub-pixel values to take on more extreme values by introducing errors in the light generated by each sub-pixel, but with these errors being compensated by corresponding errors in other sub-pixels.

In more detail, the driver may be arranged to set a given sub-pixel drive value to be closer to an extreme drive value for the sub-pixel than a reference drive value which corresponds to the desired light output from the sub-pixel.

Specifically, the driver 905 can determine a reference drive value for the first sub-pixel corresponding to a desired light output from the first sub-pixel. The desired light output may correspond that described by the input pixel value/light output value after this has been compensated by contributions from other pixels (such as a specifically cross-talk or error residue compensations). The reference drive value accordingly corresponds to the light that should be produced by the sub-pixel for this to provide a light output which together with light from other sub-pixels correspond to that indicated by the received light output value (but possible compensated by error residue contributions from other sub-pixels as described later).

Thus, the reference drive value is determined to provide a desired light output which comprises a component or light output contribution from the first sub-pixel that corresponds to the received light output value for that pixel.

Thus, the reference drive value may be a drive value for which the light output from the sub-pixel results in the desired light output for the pixel in accordance with the input pixel value.

The driver 905 may determine this reference drive value and then proceed to modify it towards a more extreme value. Specifically, a bright sub-pixel may be made brighter and a dark sub-pixel may be made darker. Thus, the driver 905 is in the example arranged to determine the first sub-pixel drive value by modifying the reference drive value to be closer to a nearest end range drive value.

As a result, the resulting light output from the pixel may exhibit an error residue. The error residue may be determined based on the difference between the selected sub-pixel drive value and the reference drive value. The error residue may in some embodiments be calculated as the difference between the estimated light output and the desired light output, i.e. as the difference between light output resulting from the selected sub-pixel drive value and the light output that would result from the reference drive value. In some embodiments, the error residue may be represented directly by the difference between the selected sub-pixel drive value and the reference drive value.

The driver may then proceed to distribute the error residue to other sub-pixels and specifically to distribute the error residue over a group of sub-pixels. Typically, the group comprises a group of neighborhood sub-pixels. The neighborhood sub-pixels may specifically be a group of view neighborhood sub-pixels, i.e. the group may be selected to include sub-pixels that belong to the same view (or nearby views) as the sub-pixel for which the error residue is calculated.

The error residue is distributed by calculating compensation values to the sub-pixels of the group. Typically, the compensation value reflect how much the desired light output for the other sub-pixel should be modified in order to compensate for the error residue. The total compensation to the other sub-pixels is typically selected to correspond to the error residue, i.e. the total combined light output change for the sub-pixels of the group of sub-pixels may be selected to be substantially equal to the error in the light output for the current sub-pixel.

Thus, the error residue is distributed by determining a residue contribution to each sub-pixel of a group of close sub-pixels (typically both spatially and in view-direction). The reference value, i.e. the desired light output for each sub-pixel may then be changed to reflect this residue contribution.

As a specific example, a sub-pixel may be determined to have a reference drive value of 0.7, i.e. that a drive value of 0.7 would result in the desired light output. However, the driver 905 proceeds to select the more extreme drive value of 0.9. An error residue of 0.2 may be determined. This error residue may be distributed to two sub-pixels that are adjacent in the view. In the example, the distribution may be equal for the two sub-pixels and accordingly a residue contribution of 0.1 is calculated for each of them. The driver 905 may then proceed to change the reference value for each of these two pixel values to be reduced by 0.1. If it is determined that the desired light output for the input value for one of the sub-pixels is 0.5, this may be reduced to 0.4. Thus, the drive value for this sub-pixel may be determined based on the reference value of 0.4. The selection of the drive value may further bias the drive value towards extreme values, e.g. the drive value may be set to 0.2. Thus, an error residue for this sub-pixel of 0.2 may be determined and thus may further be distributed to other sub-pixels.

It should be noted that summation of values may preferably occur in the linear light domain. Accordingly, the approach may for example include forward and reverse gamma correction steps to convert from the drive value domain to a linear light domain.

The approach may thus introduce localized errors in order to achieve more extreme drive values. However, these errors are distributed and compensated in proximal sub-pixels. As the human visual system includes a spatial averaging effect, the localized sub-pixel variations may be compensated and may in many scenarios not be perceived by a user.

In the example, the driver 905 may generate a reference drive value for a sub-pixel such that the combination of the light output contribution for the sub-pixel when driven by this reference drive value, the light output contribution from cross-talk from other sub-pixels, and the light output corresponding to error residue compensation from other sub-pixels is substantially equal to the light output corresponding to the pixel value.

The distribution of the error residue may be by applying a spatial distribution filter to the error residues. The coefficients of the spatial distribution filter may thus indicate the distribution of the error residue to other sub-pixels.

In many embodiments, the driver 905 may be arranged to sequentially determine drive values for the sub-pixels. For example, it may start in the top left corner, proceed along the first row, then go to the left side of the second row, proceed along the second row, then go to the left side of the third row etc.

In such embodiments, the distribution of the error residue may not be symmetric but may be only to sub-pixels that are subsequent in the sequence to the sub-pixel for which the error residue is distributed. Thus, in this case the error residue is distributed only to sub-pixels for which no drive values have been determined. The approach in effect pushes the error residue forward towards the sub-pixels that have not yet been processed without affecting the sub-pixels already processed. Accordingly, the drive values may be determined in a single pass.

It will be appreciated that different distribution filters may be used in different embodiments. For example, the Floyd-Steinberg dithering weights may be used in some embodiments (where the weights are given for the sub-pixels in the same view):

$$[ \begin{matrix} & & * & \frac{7}{16} & … \\ … & \frac{3}{16} & \frac{5}{16} & \frac{1}{16} & …\end{matrix} ] ,$$

wherein * denotes the current pixel from which the error residue is distributed (i.e. denotes the reference position for the distribution filter).

Specifically, the error residue may simply be distributed to a single neighbor pixel, such as for example to the pixel below the current pixel. In such an example, the distribution filter may simply be e.g. [*0.8]^{T} (in this case, only part of the error residue is distributed, specifically only 80% of the error residue is compensated by the pixel below).

It will be appreciated that as described for the cross-talk pattern, the distribution of the residue, and specifically the residue filter, may in the same way take into account the spatial proximity between sub-pixels; the view correlation between sub-pixels; the color correlation between sub-pixels; and/or a human visual spatial contrast function.

In the previous description, the determination of the drive values has been based directly on the weaved image. Thus, the driver has been arranged to determine the sub-pixel drive values by processing the sub-pixels of the weaved image.

However, in other embodiments, the determination of the sub-pixel drive values may be combined with the generation of the weaved image. Specifically, rather than the sequential approach of first processing the received second set of view images to generate the first set of view images which are then interleaved to generate the weaved image, with this weaved image then being used to determine the drive values, the display driver 901 may proceed to determine the sub-pixel drive values by processing sub-pixels of the images of the first set of views.

For example, in some embodiments using the previously described quadratic programming, w may be a vector that comprises all values of N views. The x vector can still represent the sub-pixel values and the matrix A indicates how much each sub-pixel would be visible for each of the pixels in each view. Thus again Ax has the same size as w.

Alternatively, the input might be on a grid that corresponds somehow to the weaved image. The input might have an R, G and B value for each sub-pixel, thus supplying three times the information for more accurate rendering.

Yet another example has another weaved image with the opposite phase (view ±N/2) thus supplying twice the information for more accurate rendering.

In the previous description, the weaved image was considered in isolation from other weaved images. However, in some scenarios an image sequence is presented. Specifically, the autostereoscopic display may be used to present a video signal comprising a series of images in a series of frames.

In some embodiments, the biasing applied to individual sub-pixels may vary between subsequent images. For example, for one frame, the bias for a given pixel may be towards the pixel being switched off, but in the next it may be towards the pixel being fully on. Specifically, the driver 905 may as previously described be arranged to introduce a specific error in the light output in order to select more extreme drive values. In some embodiments, the sign of this intentional bias error may vary between subsequent frames.

As another example, instead of alternating bias, the pattern may be more complex such as e.g. using a pseudo-random pattern of biases to avoid accidental visibility of the pattern.

It will be appreciated that the above description for clarity has described embodiments of the invention with reference to different functional circuits, units and processors. However, it will be apparent that any suitable distribution of functionality between different functional circuits, units or processors may be used without detracting from the invention. For example, functionality illustrated to be performed by separate processors or controllers may be performed by the same processor or controllers. Hence, references to specific functional units or circuits are only to be seen as references to suitable means for providing the described functionality rather than indicative of a strict logical or physical structure or organization.

The invention can be implemented in any suitable form including hardware, software, firmware or any combination of these. The invention may optionally be implemented at least partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units, circuits and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements, circuits or method steps may be implemented by e.g. a single circuit, unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate. Furthermore, the order of features in the claims do not imply any specific order in which the features must be worked and in particular the order of individual steps in a method claim does not imply that the steps must be performed in this order. Rather, the steps may be performed in any suitable order. In addition, singular references do not exclude a plurality. Thus references to “a”, “an”, “first”, “second” etc. do not preclude a plurality. Reference signs in the claims are provided merely as a clarifying example shall not be construed as limiting the scope of the claims in any way.

1. An apparatus for generating a plurality of sub-pixel drive values for a plurality of sub-pixels of an autostereoscopic display, the apparatus comprising:
a first receiver arranged to receive a plurality of light output values for a plurality of pixels of at least one image, wherein the each of the plurality of pixels comprise sub-pixels;
a driver, wherein the driver is arranged to generate a first drive value for a first sub-pixel in response to at least one of:
a first light output value, wherein the first light output value is for a first pixel of which the first sub-pixel is a part,
a first sub-pixel value of at least a second sub-pixel, wherein the second sub-pixel is different from the first sub-pixel,
a cross-talk pattern reflecting sub-pixel cross-talk characteristics of the plurality of sub-pixels of the autostereoscopic display;
wherein the driver is arranged to bias the plurality of sub-pixel drive values for the plurality of sub-pixels towards extreme drive values,
wherein the plurality of sub-pixel drive values are optimized by minimizing a penalty measure,
wherein the penalty measure is based on a difference between estimated light output resulting from a selected sub-pixel drive values for a set of sub-pixels and the first light output,
wherein the penalty measure is also based on a difference between at least one sub-pixel drive value of the selected sub-pixel drive values to a nearest end range value for the at least one sub-pixel drive value of the selected sub-pixel drive values.

2. The apparatus of claim 1 wherein the autostereoscopic display comprises a display panel, the display panel comprising the plurality of sub-pixels and a view forming optical element, the view forming optical element overlaying the display panel, wherein the cross-talk pattern reflects a spatial proximity between the sub-pixels in the display panel.

3. The apparatus of claim 1 wherein the autostereoscopic display comprises a display panel, display panel comprising the plurality of sub-pixels and a view forming optical element, the view forming optical element overlaying the display panel, wherein the cross-talk pattern reflects a view correlation between plurality of sub-pixels of the display panel.

4. The apparatus of claim 1 wherein the cross-talk pattern reflects a human visual spatial contrast function reflecting sensitivity of a human observer to spatial contrast as a function of spatial frequency.

5. The apparatus of claim 1 wherein the driver is arranged to determine a reference drive value for the first sub-pixel,
wherein the reference drive value corresponds to a desired light output from the first sub-pixel,
wherein the desired light output comprises a light output contribution from the first sub-pixel corresponding to the light output value for the first pixel,
wherein the first sub-pixel drive value is determined by modifying the reference drive value to be closer to a nearest end range drive value.

6. The apparatus of claim 5 wherein the driver is arranged to determine an error residue in response to a difference measure for the first sub-pixel drive value relative to the reference drive value, wherein the driver is arranged to distribute the error residue over a group of sub-pixels.

7. The apparatus of claim 6 wherein the driver is arranged to determine the reference drive value in response to error residue contributions to the first sub-pixel from other sub-pixels.

8. The apparatus of claim 7 wherein the driver is arranged to distribute the error residue in response to at least one of:
a spatial proximity between the plurality of sub-pixels;
a view correlation between the plurality of sub-pixels;
a color correlation between the plurality of sub-pixels;
a human visual spatial contrast function.

9. The apparatus of claim 7 wherein the driver is arranged to sequentially determine drive values for the plurality of sub-pixels; and to distribute error residue for a sub-pixel to at least one of the sub-pixels subsequent to the sub-pixel.

10. The apparatus of claim 1 further comprising:
a second receiver, wherein the second receiver is arranged to receive at least one image of a second set of views;
an image combiner, wherein the image combiner is arranged to generate a weaved image from the at least one image of the second set of views;
wherein the driver is arranged to determine the sub-pixel drive values by processing at least a portion of sub-pixels of the weaved image
wherein the autostereoscopic display is arranged to display a first set of views by presenting a weaved image comprising interleaved images for the first set of views.

11. The apparatus of claim 1 further comprising:
a second receiver, wherein the second receiver is arranged to receive at least one image of a second set of views;
wherein the driver is arranged to determine the sub-pixel drive values as sub-pixel drive values of the weaved image by processing at least a portion of sub-pixels of the at least one image of a second set of views,
wherein the autostereoscopic display is arranged to display a first set of views by presenting a weaved image comprising interleaved images of the first set of views.

12. The apparatus of claim 1 wherein the at least one image is an image of a sequence of image frames and the driver is arranged to vary the bias for individual sub-pixels of the images between subsequent images.

13. A method of generating a plurality of sub-pixel drive values for a plurality of sub-pixels of an autostereoscopic display, the method comprising:
receiving light output values for a plurality of pixels of at least one image, wherein the each of the plurality of pixels comprise sub-pixels;
generating the plurality of sub-pixel drive values including a first drive value for a first sub-pixel in response to at least one of:
a first light output value, wherein the first light output value is for a first pixel of which the first sub-pixel is a part,
a first sub-pixel value of at least a second sub-pixel, wherein the second sub-pixel is different from the first sub-pixel,
a cross-talk pattern reflecting sub-pixel cross-talk characteristics of the plurality of sub-pixels of the autostereoscopic display;
wherein generating the sub-pixel drive values comprises biasing the plurality of sub-pixel drive values for the plurality of sub-pixels towards extreme drive values,
wherein the subpixel drive values are optimized by minimizing a penalty measure,
wherein the penalty measure is based on a difference between estimated light output resulting from a selected sub-pixel drive values for a set of subpixels and the first light output,
wherein the penalty measure is also based a difference between at least one sub-pixel drive value of the selected sub-pixel drive values to a nearest end range value for the at least one sub-pixel drive value of the selected sub-pixel drive values.

14. A computer program product comprising computer program code means arranged to perform all the steps of claim 13 when the computer program is run on a computer processor circuit.
